(19) United States
(12) Patent Application Publication
(10) Pub. No.: US 2009/0311162 A1
(43) Pub. Date: Dec. 17, 2009

(54) ALUMINUM NITRIDE SINTERED BODY AND MANUFACTURING METHOD THEREOF

(76) Inventors: Tatsuo Esaki, Yamaguchi (JP); Hideki Satou, Yamaguchi (JP)

Correspondence Address: LADAS & PARRY LLP, 224 SOUTH MICHIGAN AVENUE, SUITE 1600, CHICAGO, IL, 60604, US

(21) Appl. No.: 12/376,158

(22) PCT Filed: Jul. 26, 2007
(86) PCT No.: PCT/JP2007/064700

§ 371 Date: Mar. 30, 2009

(30) Foreign Application Priority Data
Aug. 7, 2006 (JP) 2006-214498

(51) Int. Cl. C01B 21/072

(52) U.S. Cl. 423/412

(57) ABSTRACT

An aluminum nitride sintered body in which the ratio of a peak area S2 of a diffraction peak at 2θ=34° or more and 35° or less corresponding to an aluminum oxynitride phase to a peak area S1 of a diffraction peak of an aluminum nitride crystal face [100] in X-ray diffraction, i.e. S2/S1, is 0.01 or more and 0.3 or less, and the spin concentration at a magnetic field between 336 mT and 342 mT as measured by an electron spin resonance method is 1×10¹⁵ spins/cm³ or more and 1×10²⁰ spins/cm³ or less. This is manufactured by: mixing a predetermined amount of the aluminum nitride powder and the α-alumina powder whose ratio of average particle diameter to that of aluminum nitride powder is within the range of 0.3 or more and 0.8 or less; and sintering the mixed powder at ambient-pressure. Accordingly, it is possible to provide the aluminum nitride sintered body whose volume resistivity is controlled within the range of 1×10⁸ Ω·cm or more and 1×10¹² Ω·cm or less, and the volume resistivity can be stably maintained even heated up to 1950° C. for jointing.

### TECHNICAL FIELD

The present invention relates to a novel aluminum nitride sintered body which is suitably used as an electrostatic chuck for mounting thereon and treating the semiconductor wafer in a semiconductor manufacturing equipment. More specifically, the present invention relates to the sintered body which exhibits strong adsorption force for adsorbing a semiconductor wafer and is surely capable of absorption and desorption of wafer, and which is favorable in thermal stability when used as an electrostatic chuck.

### BACKGROUND ART

About semiconductor manufacturing equipment for giving treatment such as coating and etching to a semiconductor wafer like silicon wafer, as a table for mounting the semiconductor wafer, a ceramic sheet-type sintered body, in which metal layers which act as electrodes are buried, is used as a electrostatic chuck. In addition, as for an electrostatic chuck, there is a case where metal layers which act as heaters are buried together with the electrodes.

Moreover, in the semiconductor manufacturing equipment, as an etching gas, halogen gas like chlorine-containing gas or fluorine-containing gas is often used. Therefore, the base material is required to have corrosion resistance to halogen gas. In recent years, as a ceramic to be used for the above applications, aluminum nitride sintered body which exhibits favorable corrosion resistance to halogen gas and excellent thermal conductivity has been suitably used.

Meanwhile, in the semiconductor manufacturing equipment, in order to use the electrostatic chuck as a retaining device for mounting a wafer, it is necessary to make the adsorption force of the electrostatic chuck larger. In general, as adsorption force, coulomb force and Johnson-Rahbek force are known; it is known that the latter provides higher adsorption force regardless of thickness of the base material. Examples of the factor to determine which power between the two powers acts include volume resistivity of the base material. In other words, it is known that when the volume resistivity of the base material is 10⁸ Ω·cm or more and 10¹² Ω·cm or less, Johnson-Rahbek force acts; meanwhile, when the volume resistivity is 10¹³ Ω·cm or more, coulomb force acts. Because of this, it becomes necessary to control the volume resistivity of the base material within the range of 10⁸ Ω·cm or more and 10¹² Ω·cm or less.

Conventionally, an aluminum nitride sintered body, in which impurities are solidly solved in the particles by sintering using hot-press method to control the volume resistivity within the range of 10⁹ to 10¹³ Ω·cm and metal members are buried, is known (See Patent document 1.). By this method, it is assumed that due to the sintering by hot-press method, carbon, oxygen, and so on are solidly solved that may reduce the volume resistivity. The solidly solved carbon and oxygen are thought to be provided from powder material, metal members, and carbon in the refractory lining so that amount of solid solubility is hard to control. Moreover, into the composition of Example 1 of the Patent document 1, oxygen source is not directly added, so even if aluminum oxynitride phase is assumed to be produced by the oxygen contained in the aluminum nitride powder material, the amount is extremely small compared with that of the present invention. Because of this, it is thought that volume resistivity is not maintained after heat history like thermal treatment at high temperature. Thus, when the manufactured aluminum nitride sintered body is further thermally treated (about 1650° C. to 1850° C.) such as jointing at a time of working to make an electrostatic chuck, and so on, the volume resistivity increases. Further, in the method, it is capable of lowering the volume resistivity by inserting the metal members. In fact, the present inventors produced a sintered body which did not contain the metal member under the condition of Example 1 of the Patent document 1 by hot-press method; however the volume resistivity did not drop to less than 10¹³ Ω·cm. Still further, compared with general sintering at ambient pressure, manufacturing equipment becomes larger, thereby productivity also becomes worse.

On the other hand, a method for adding γ-alumina to aluminum nitride and sintering the mixture is also known (See Patent document 2.). The method has a feature that γ-alumina crystals form a complex with maintaining the individual form. In the method, the volume resistivity at room temperature is 10¹³ Ω·cm or more.

### Patent Document 1: Japanese Patent No. 3670416

### Patent Document 2: Japanese Patent Application Laid-Open (JP-A) No. 10-338574

### DISCLOSURE OF THE INVENTION

### Problems to be Solved by the Invention

Accordingly, an object of the present invention is to provide an aluminum nitride sintered body which can be used in an environment using plasma-halogen gas such as semiconductor manufacturing equipment, wherein the aluminum nitride sintered body is capable of controlling the volume resistivity between 10⁸ Ω·cm or more and 10¹² Ω·cm or less, and the volume resistivity can be stably maintained even when thermally treated at a temperature up to 1950° C. for jointing and the like.

### Means for Solving the Problems

The present inventors had seriously studied to solve the above problems. As a result, by controlling the amount of defects and aluminum oxynitride phase both in the aluminum nitride sintered body, they had succeeded to obtain an aluminum nitride sintered body which exhibits excellent low-volume resistivity and shows few changes in volume resistivity by heat history; then, the present invention was completed.

As it were, the present invention is an aluminum nitride sintered body in which the ratio of a peak area S2 of a diffraction peak at 2θ=34° or more and 35° or less corresponding to an aluminum oxynitride phase to a peak area S1 of a diffraction peak of an aluminum nitride crystal face [100] in X-ray diffraction (Hereinafter, refer to as “XRD”.), i.e. S2/S1, is 0.01 or more and 0.3 or less, preferably 0.01 or more and 0.2 or less, and the spin concentration at a magnetic field between 336 mT and 342 mT as measured by an electron spin resonance method (Hereinafter, refer to as “ESR”.) is 1×10¹⁵ spins/cm³ or more and 1×10²⁰ spins/cm³ or less, preferably 1×10¹⁶ spins/cm³ or more and 1×10¹⁹ spins/cm³ or less.

Moreover, the present invention also provides a method for manufacturing the aluminum nitride sintered body comprising the step of mixing a predetermined amount of the aluminum nitride powder and the α-alumina powder whose ratio of average particle diameter to that of aluminum nitride powder is within the range of 0.3 or more and 0.8 or less, preferably 0.4 or more and 0.6 or less; and sintering the mixed powder at ambient-pressure and a certain temperature under nitrogen atmosphere.

### EFFECTS OF THE INVENTION

As above, the aluminum nitride sintered body of the present invention has defects equivalent to the spin concentration of 1×10¹⁵ spins/cm³ or more and 1×10²⁰ spins/cm³ or less at a magnetic field between 336 mT and 342 mT. The defects observed within the above range of magnetic field is assumed to be attributed to the solidly solved oxygen; therefore, the more numbers of defects increases, the less the volume resistivity becomes. In general, volume resistivity decreases with the rise of temperature; when volume resistivity is set to 1×10⁸ Ω·cm or more and 1×10¹² Ω·cm or less at about room temperature, the volume resistivity becomes below 1×10⁸ Ω·cm within the temperature range between 200° C. and 600° C. where the aluminum nitride sintered body is used as a material for semiconductor manufacturing equipment. However, within the range of spin concentration to which the above defects of the invention are attributed, decrease of volume resistivity is inhibited compared with that of conventional aluminum nitride sintered body, volume resistivity of 1×10⁸ Ω·cm or more and 1×10¹² Ω·cm or less can be maintained within the temperature range from room temperature to 500° C. Moreover, in case where a diffraction peak at 2θ=34° or more and 35° or less corresponding to the aluminum oxynitride phase in the XRD exists, spin concentration is not changed by heat history, spin concentration after heating up to 1700° C. or more and 1900° C. or less as the sintering temperature of aluminum nitride is not changed, either.

Since volume resistivity of the aluminum nitride sintered body of the present invention is 1×10⁸ Ω·cm or more and 1×10¹² Ω·cm or less, the sintered body can be used for electrostatic chuck having strong adsorption force. In addition, in case of forming a plate having a plurality of electrode layers by jointing the sintered bodies, as the sintered bodies are heated up to the sintering temperature of aluminum nitride or more, if a general aluminum nitride sintered body is used, volume resistivity increases in proportion to the heat history. Nevertheless, about the aluminum nitride sintered body of the invention, by controlling the amount of defects in the aluminum nitride detected at a magnetic field between 336 mT and 342 mT in ESR measurement, change of volume resistivity attributed to the heat history, e.g. being heated at high temperature, can be hardly seen. Thus, it is capable of producing an electrostatic chuck whose adsorption force is not reduced even if it is heated up to about the sintering temperature of aluminum nitride. Accordingly, the aluminum nitride sintered body can be extremely effectively used as a material for a heater incorporated in the electrode inner layers of a multilayer structure or electrostatic chuck.

Further, the aluminum nitride sintered body of the invention can be manufactured under a condition of burning at ambient-pressure so that it can be produced with relatively inexpensive cost.

### BEST MODE FOR CARRYING OUT THE INVENTION

### Aluminum Nitride Sintered Body

In the measurement result of the aluminum nitride sintered body of the present invention by using ESR, spin concentration at a magnetic field between 336 mT or more and 342 mT or less is 1×10¹⁵ spins/cm³ or more and 1×10²⁰ spins/cm³ or less, preferably 1×10¹⁶ spins/cm³ or more and 1×10¹⁹ spins/cm³ or less. The present inventors discovered that the volume resistivity decreased with increase of spin concentration at room-temperature level. As it were, when spin concentration is smaller than 1×10¹⁵ spins/cm³, volume resistivity becomes larger and exceeds 1×10¹³ Ω·m; while, when spin concentration is larger than 1×10²⁰ spins/cm³, volume resistivity becomes smaller and drops to less than 1×10⁸ Ω·m. On the other hand, at high-temperature range about 500° C., regardless of spin concentration, volume resistivity becomes 1×10⁸ Ω·m or more and 1×10¹² Ω·m or less. Therefore, even if the aluminum nitride sintered body is used for electrostatic chuck and the like, it shows stable property at a temperature from room temperature as used temperature range to several hundred degrees centigrade.

In the measurement by the above ESR, it is assumed that the spin concentration at a magnetic field between 336 mT or more and 342 mT or less is corresponding to the amount of lattice defect attributed to oxygen. Namely, it is believed that the volume resistivity is related to the amount of lattice defect attributed to oxygen. The lattice defect attributed to oxygen decreases with heat history, particularly, discharge of solidly solved oxygen being heated at the vicinity of sintering temperature to outside of the sintered body. However, in the aluminum nitride sintered body of the invention, as the spin concentration is not changed, the volume resistivity is not changed, either. This is assumed that since the aluminum nitride sintered body includes an aluminum oxynitride phase, when solidly solved oxygen is discharged, re-solid-solution from the aluminum oxynitride phase is caused; eventually the amount of lattice defect are not changed.

On the other hand, in the aluminum nitride sintered body of the invention, with regard to the concentration of aluminum oxynitride, it is important that the ratio of a peak area S2 of a diffraction peak at 2θ=34° or more and 35° or less corresponding to an aluminum oxynitride phase to a peak area S1 of a diffraction peak of an aluminum nitride crystal face [100] in X-ray diffraction, i.e. S2/S1, is 0.01 or more and 0.3 or less. As it were, when the above S2/S1 is smaller than 0.01, retention capacity of the volume resistivity of the sintered body by heat history cannot be observed; when it is larger than 0.3, ratio of aluminum oxynitride in the aluminum nitride sintered body becomes high that raises the volume resistivity.

Concentration (as total content) of metal other than aluminum in the aluminum nitride sintered body of the invention is preferably 400 ppm or less, more preferably 300 ppm or less. If concentration of metal impurities is higher than 400 ppm, when the sintered body is used as a material for semiconductor manufacturing equipment, there is a possibility of contamination in the wafer and chamber by that. Moreover, by the metal impurities, type of lattice defect may be changed or the lattice defect may become a medium which brings the solidly solved oxygen out from the aluminum nitride particle.

In terms of distribution of aluminum oxynitride phase in the aluminum nitride sintered body of the invention, it is not specifically restricted as long as the aluminum oxynitride phase is evenly distributed; in order to efficiently supply oxygen to the defects, the aluminum oxynitride phase is preferably exists in a form of spherical shape in between aluminum nitride particles (interface of two particles) or within respective aluminum nitride particles. The layer thickness of aluminum oxynitride when existing along interface of two particles is preferably 1 μm or less. In case where the aluminum oxynitride phase exists in the aluminum nitride particle, particle diameter thereof is preferably 0.1 μm or less.

Other properties and modes of the sintered body are not specifically limited to, average particle diameter of the aluminum nitride is preferably 10 μm or less. The larger the particle diameter becomes, the lower the volume resistivity slightly tends to become.

The state of the above aluminum oxynitride can be observed by e.g. scanning electron microscope (Hereinafter, abbreviated to “SEM”.).

Moreover, thermal conductivity, when used especially as a material of semiconductor manufacturing equipment, is preferably 50 W/m·K or more and 100 W/m·K or less.

### Manufacturing Method of Aluminum Nitride

In the invention, by complying with below-described several conditions, aluminum nitride sintered body can be produced by a combination of known methods. Specifically, it can be produced by the steps of: mixing a powder for sintering including aluminum nitride (AlN) powder and predetermined amount of α-alumina powder together with an organic binder to prepare a molding material like granulated powder or paste; molding the molding material by a known method; delipidating the obtained compact; and sintering the compact.

The aluminum nitride powder used for the invention is not specifically limited to; total content rate of the metal other than aluminum is suitably 400 ppm or less, preferably 300 ppm or less. In other words, when the metal content rate exceeds 400 ppm, in case where the obtained aluminum nitride sintered body is used in the semiconductor manufacturing equipment, it might be involved with contamination of wafer. In addition, when the amount of metal impurities increases, metal oxide may be separately generated, volume resistivity may be out of the range of 1×10⁸ Ω·m or more and 1×10¹² Ω·m or less.

The average particle diameter of α-alumina powder to be used in the invention is 0.3 μm or more and 2 μm or less, preferably 0.5 μm or more and 1 μm or less. When it is less than 0.3 μm, structure of aluminum oxynitride is changed so that diffraction peak at 2θ=34° or more and 35° or less by XRD is low or is not detected, retention capacity of the volume resistivity by heat history is lost. Thus, when thermal treatment like jointing is given at a temperature of 1700° C. or more, volume resistivity becomes high and it becomes 1×10¹³ Ω·m or more. Moreover, when α-alumina having the average particle diameter of over 2 μm, distribution of defects in the sintered body becomes unhomogeneous, thereby scattering in volume resistivity occurs and the volume resistivity sometimes shows less than 1×10⁸ Ω·m or 1×10¹³ Ω·m or more.

So as to reduce the total content of metal other than aluminum in the obtained aluminum nitride sintered body, it is preferable to use highly-pure α-alumina. The purity is preferably 99% or more, more preferably 99.5% or more.

Together with the above requirement, the α-alumina powder to be used for the invention is a powder whose size is 0.3 times or more and 0.8 times or less, preferably 0.4 times or more and 0.6 times or less of average particle diameter of the aluminum nitride powder. Namely, when α-alumina whose size is less than 0.3 times or more than 0.8 times of the average particle diameter is used, it significantly inhibits sintering of aluminum nitride and densification does not tend to occur under a step of sintering at room temperature.

It should be noted that the average particle diameter of the aluminum nitride and α-alumina to be used for the above material is the number-average particle diameter determined by laser diffraction method.

In the invention, addition amount of the α-alumina powder to the aluminum nitride powder, to 100 parts by mass of aluminum nitride powder, is 0.5 parts by mass or more and 5 parts by mass or less, preferably 1 parts by mass or more and 4 parts by mass or less. When the addition amount is less than 0.5 parts by mass, since production of aluminum oxynitride phase does not occur or the produced amount is small, retention capacity of volume resistivity by heat history is lost. Moreover, when the addition amount is more than 5 parts by mass, degree of sintering becomes worse thereby densification cannot be occurred.

In the invention, it is important not to use sintering additive. If a conventional sintering additive for aluminum nitride like yttrium oxide and calcium oxide is used, regardless of the quantity, it reacts with α-alumina and produces aluminate compound, thereby inhibits production of aluminum oxynitride phase. Further, as sintering additive takes the solidly solved oxygen in the aluminum nitride crystal, the volume resistivity becomes higher.

As an organic binder to be used in the above method, the examples include, but not limited to: in general, polyvinylbutyral, polymethyl methacrylate, carboxy methyl cellulose, polyvinylpyrolidone, polyethylene glycol, polyethylene oxide, polyethylene, polypropylene, ethylene-vinyl acetate copolymer, polystyrene, and polyacrylic acid. Depending on the type to be used, such an organic binder is generally used within the range of 0.1 parts by mass or more and 30 parts by mass or less to 100 parts by mass of the above powder for burning.

About preparation of material for forming, as required, dispersant like long-chain hydrocarbon ether, solvent such as toluene and ethanol, as well as plasticizer like phthalic acid can be used with adequate amount.

Production of a formed product by using the above material for forming is carried out by a known method such as extrusion molding, injection molding, doctor-blade method, and press forming.

Defatting, in general, is carried out by heating the formed product in air at a temperature between 300° C. and 900° C. for 1 hour or more and 3 hours or less; burning is carried out by heating the defatted body after defatting in nitrogen atmosphere at a temperature between 1800° C. and 1950° C., preferably between 1850° C. and 1950° C. When the burning temperature is less than 1800° C., sintering is difficult to develop. On the other hand, when the burning temperature is over 1950° C., spin concentration at a magnetic field between 336 mT and 342 mT in ESR becomes higher so that value of volume resistance becomes smaller than 1×10⁸ Ω·m. Burning time is determined depending on the content of α-alumina to be used; in view of densification and microfabrication to make the particle diameter of aluminum nitride to be 10 μm or less, it is 30 hours or more and 100 hours or less, preferably 40 hours or more and 80 hours or less. Burning of the invention is carried out in nonoxidative atomosphere such as nitrogen or inert gas; conventional burning method which does not give external pressure to the defatted body is adopted (Hereinafter, refer to this burning method as “ambient-pressure burning”.). Meanwhile, the hot-press burning which gives external pressure to the defatted body cannot be used for burning of the present invention. When the hot-press burning is carried out to the material composition of the invention, aluminum oxynitride mainly becomes spinel-type, which does not contribute to the thermal stability of the volume resistivity.

Application of the aluminum nitride sintered body of the present invention is not specifically limited to; since its volume resistivity is 1×10⁸ Ω·m or more and 1×10¹² Ω·m or less, it can be suitably used for etcher, electrostatic chuck for CVD device, and electrostatic chuck having heater.

### EXAMPLES

The invention will be more specifically described by way of the following Examples and Comparative examples. Obviously, it should be understood that the present invention is not limited by the following Examples.

Various measurements in Examples and Comparative examples were carried out in accordance with the method described below.

(1) XRD Measurement

Test pieces of 15 mm in diameter and 1 mm in thickness were produced and diffraction peaks were measured by using an X-ray diffraction analysis equipment, “RINT 1200” (trade name) manufactured by Rigaku Corporation. Then, the ratio of a peak area S2 (integral intensity) of a diffraction peak at 2θ=34° or more and 35° or less to a peak area S1 of a diffraction peak (2θ=33.2°) of an aluminum nitride crystal face [100], i.e. S2/S1 was calculated.

(2) ESR Measurement

Test pieces of 2 mm×2 mm×20 mm were cut from a sintered body and the spin concentration was measured by an electron spin resonance equipment, “JES-FE1XG” (trade name) manufactured by JEOL Ltd. From the obtained spectrum, integral curve was obtained by using analysis software (“GRAMS” manufactured by Thermo Electron Corporation (former Thermo Galactic Corporation)); thereafter, peaks were separated by the software along the Gaussian curve. Then, peak area was measured at a magnetic field between 336 mT and 342 mT. Spin quantity was calculated from the ratio to peak area of the known spin quantity samples, and the value divided by the volume of sample for measurement was defined as the spin concentration.

(3) Volume Resistivity Measurement

Test pieces of 35 mm×35 mm×1 mm were cut from a sintered body, by the method in accordance with JIS C2141, volume resistivity was measured by using volume resistivity measurement equipment, “R8340” (trade name) manufactured by ADVANTEST CORPORATION.

(4) Observation of State of Aluminum Oxynitride

Test pieces of 5 mm×5 mm×1 mm were cut from arbitrary areas of the aluminum nitride sintered body, these were observed by electron scanning microscope, “Quanta 200” (trade name) manufactured by FEI Company at a magnification of 1000 times or more and 10000 times or less.

(5) Measurement of Average Particle Diameter of the Raw material

Material powder was dispersed in 5 weight % pyrophoric acid soda solution by an ultrasonic homogenizer, “US-300T” (trade name) manufactured by NISSEI Corporation to prepare a diluted-dispersed liquid. Then, the powder in the solution was observed by laser diffraction particle size distribution measurement equipment, “MICROTRAC HRA” (trade name) manufactured by NIKKISO CO., LTD. to obtain the number-average particle diameter.

### Example 1

To 100 parts by mass of aluminum nitride powder (produced by Tokuyama Corporation, average particle diameter: 1.0 μm, total metal concentration: 240 ppm), 2 parts by mass of α-alumina powder (produced by Sumitomo Chemical Co., Ltd., average particle diameter: 0.6 μm, ratio to average particle diameter of aluminum nitride powder: 0.6) and 4 parts by mass of organic binder were added and mixed in toluene/ethanol; and then, the mixed material was granulated by spray dryer to obtain granulated powder having a particle diameter of 70 μm.

The granulated powder was press-formed and a formed product of 260 mm in diameter and 10 mm in thickness was produced. The formed product was heated at 550° C. for 3 hours for defatting; followed by putting them up into a boron-nitride-made box-type container and burnt under nitrogen atmosphere at a temperature of 1900° C. for 50 hours; an aluminum nitride sintered body was obtained.

Test pieces to be used for each measurement were cut from the obtained aluminum nitride sintered body and evaluated. As a result of XRD measurement, S2/S1 was 0.10. While, as a result of ESR measurement, the obtained spin concentration at a magnetic field between 336 mT and 342 mT was 3.4×10¹⁸ spins/cm³. Moreover, when volume resistivities at 25° C. and 500° C. were measured, the volume resistivities were respectively 2.0×10¹¹ Ω·cm and 2.5×10⁸ Ω·cm.

Thermal conductivity of the obtained aluminum nitride sintered body was 60 W/m·K. When SEM observation was carried out about the fracture surface, average particle diameter of aluminum nitride was 4.6 μm. By observing about aluminum oxynitride phase by SEM, it existed in aluminum nitride two-particle interface and inside aluminum nitride particles. The aluminum oxynitride phase in the interface was a layer whose size was about 0.5 μm; while, the aluminum oxynitride phase existed inside aluminum nitride particles was spherical shape of 0.1 μm in diameter.

Further, from the obtained base material, two test pieces of 40 mm in diameter and 6 mm in thickness were cut, and paste mainly containing aluminum nitride was coated on one surface of each test pieces; then, two of them were adhered each other such that the pasted surfaces become inside. Later, the adhered piece was heated at 70° C. for 1 hour for drying; thereafter, defatting was carried out at 500° C. for 1 hour. Following to this, in a hot-press furnace, the test pieces were jointed at 1850° C. for 6 hours under a stamping pressure of 24 MPa. The jointed piece was processed; from the piece of an area where does not contain the jointed interface, test pieces having a size of 35 mm×35 mm×1 mm was cut, and the volume resistivities at 25° C. and 500° C. were measured again. The volume resistivities were respectively 3.1×10¹¹ Ω·cm and 4.5×10⁸ Ω·cm.

### Examples 2 to 4

Except for changing the addition amount of α-alumina, Examples 2 to 4 were carried out in the same manner as Example 1 to obtain an aluminum nitride sintered body. Manufacturing conditions of the sintered body are shown in Table 1; and evaluation results of the sintered body are shown in Table 2.

### Example 5

Except for changing particle diameter of α-alumina, Example 5 was carried out in the same manner as Example 1 to obtain an aluminum nitride sintered body. Manufacturing conditions of the sintered body are shown in Table 1; and evaluation results of the sintered body are shown in Table 2.

### Examples 6 and 7

Except for changing the burning temperature, Examples 6 and 7 were carried out in the same manner as Example 1 to obtain an aluminum nitride sintered body. Manufacturing conditions of the sintered body are shown in Table 1; and evaluation results of the sintered body are shown in Table 2.

### Examples 8 and 9

Except for changing the burning time, Examples 8 and 9 were carried out in the same manner as Example 1 to obtain an aluminum nitride sintered body. Manufacturing conditions of the sintered body are shown in Table 1; and evaluation results of the sintered body are shown in Table 2.

### Example 10

Except for changing average particle diameter of aluminum nitride powder and α-alumina powder, Example 10 was carried out in the same manner as Example 1 to obtain an aluminum nitride sintered body. Manufacturing conditions of the sintered body are shown in Table 1; and evaluation results of the sintered body are shown in Table 2.

### Comparative Example 1

To 100 parts by mass of aluminum nitride powder (produced by Tokuyama Corporation, average particle diameter: 1.0 μm), 0.1 parts by mass of α-alumina powder (produced by Sumitomo Chemical Co., Ltd., average particle diameter: 0.6 μm, ratio to average particle diameter of aluminum nitride powder: 0.6) and 4 parts by mass of organic binder were added and mixed in toluene/ethanol; thereafter, the mixed material was granulated by spray dryer to obtain granulated powder having a particle diameter of 70 μm.

The granulated particles were press-formed and a formed product of 260 mm in diameter and 10 mm in thickness was produced. The formed product was heated at 550° C. for 3 hours for defatting and then put up into a boron-nitride-made box-type container and burnt under nitrogen atmosphere at a temperature of 1900° C. for 50 hours to obtain an aluminum nitride sintered body.

From the obtained aluminum nitride sintered body, test pieces used for each measurement were cut and evaluated. As a result of XRD measurement, no peak was observed within the range of 2θ=34° or more and 350 or less. In addition, as a consequent of ESR measurement, the obtained spin concentration at a magnetic field between 336 mT and 342 mT was 6.5×10¹¹ spins/cm³. Further, when volume resistivities at 25° C. and 500° C. were measured, each of which were 8.1×10¹³ Ω·cm and 2.5×10⁷ Ω·cm. Still further, from the obtained base material, two test pieces of 40 mm in diameter and 6 mm in thickness were cut, and paste mainly containing aluminum nitride was coated on one surface of each test piece; then, two of them were adhered each other such that the pasted surfaces become inside. Later, the adhered piece was heated at 70° C. for 1 hour for drying; thereafter, defatting was carried out at 500° C. for 1 hour. Following to this, in a hot-press furnace, the test pieces were jointed at 1850° C. for 6 hours under a stamping pressure of 24 MPa. The jointed piece was processed; from the piece of an area where does not contain the jointed interface, test pieces having a size of 35 mm×35 mm×1 mm was cut, and the volume resistivities at 25° C. and 500° C. were measured again. The volume resistivities were respectively 2.1×10¹⁴ Ω·cm and 7.6×10⁸ Ω·cm. When SEM observation was carried out about the fracture surface, the average particle diameter of aluminum nitride was 6.5 μm and aluminum oxynitride phase was not observed.

### Comparative Example 2

To 100 parts by mass of aluminum nitride powder (produced by Tokuyama Corporation, average particle diameter: 1.0 μm), 20 parts by mass of α-alumina powder (produced by Sumitomo Chemical Co., Ltd., average particle diameter: 0.6 μm, ratio to average particle diameter of aluminum nitride powder: 0.6) and 4 parts by mass of organic binder were added and mixed in toluene/ethanol; thereafter, the mixed material was granulated by spray dryer to obtain granulated powder having a particle diameter of 70 μm.

Under the same condition as that of Example 1, defatting and burning were carried out, and a white sintered body was obtained. However, it was found out that densification of the structure was not observed by SEM.

As a result of XRD analysis, other than aluminum nitride, α-alumina phase was detected; any other phases were not observed. Moreover, as a result of ESR measurement, spin concentration was 8.1×10²⁴ spins/cm³ and volume resistivity at room temperature was 2.6×10⁷ Ω·cm.

### Comparative Examples 3 and 4

Except for changing ratio of average particle diameter of α-alumina powder to that of aluminum nitride powder by changing average particle diameter of aluminum nitride powder or α-alumina powder, Comparative examples 3 and 4 were carried out in the same manner as Example 1 and aluminum nitride sintered bodies were obtained. The manufacturing conditions of the sintered bodies are shown in Table 1 and the evaluation results of the sintered bodies are shown in Table 2.

### Comparative Examples 5 and 6

Except for changing addition amount of α-alumina, Comparative examples 5 and 6 were carried out in the same manner as Example 1 and aluminum nitride sintered bodies were obtained. The manufacturing conditions of the sintered bodies are shown in Table 1 and the evaluation results of the sintered bodies are shown in Table 2.

TABLE 1

| | Aluminum nitride | | | α-alumina | | α-alumina PD/ | | | |
|---|---|---|---|---|---|---|---|---|---|
| | | Metal | Addition | | Addition | aluminum | | | Burning |
| | Particle | concen- | amount | Particle | amount | nitride PD | Burning | Burning | method |
| | diameter | tration | (parts by | diameter | (parts by | (PD = Particle | temperature | time | (Other |
| | (μm) | (ppm) | weight) | (μm) | weight) | diameter) | (° C.) | (hour) | conditions) |
| Example 1 | 1.0 | 240 | 100 | 0.6 | 2.0 | 0.6 | 1900 | 50 | burning at |
| | | | | | | | | | ambient- |
| | | | | | | | | | pressure |
| Example 2 | 1.0 | 240 | 100 | 0.6 | 0.5 | 0.6 | 1900 | 50 | burning at |
| | | | | | | | | | ambient- |
| | | | | | | | | | pressure |
| Example 3 | 1.0 | 240 | 100 | 0.6 | 1.5 | 0.6 | 1900 | 50 | burning at |
| | | | | | | | | | ambient- |
| | | | | | | | | | pressure |
| Example 4 | 1.0 | 240 | 100 | 0.6 | 3.5 | 0.6 | 1900 | 50 | burning at |
| | | | | | | | | | ambient- |
| | | | | | | | | | pressure |
| Example 5 | 1.0 | 240 | 100 | 0.4 | 2.0 | 0.4 | 1900 | 50 | burning at |
| | | | | | | | | | ambient- |
| | | | | | | | | | pressure |
| Example 6 | 1.0 | 240 | 100 | 0.6 | 2.0 | 0.6 | 1850 | 50 | burning at |
| | | | | | | | | | ambient- |
| | | | | | | | | | pressure |
| Example 7 | 1.0 | 240 | 100 | 0.6 | 2.0 | 0.6 | 1950 | 50 | burning at |
| | | | | | | | | | ambient- |
| | | | | | | | | | pressure |
| Example 8 | 1.0 | 240 | 100 | 0.6 | 2.0 | 0.6 | 1900 | 80 | burning at |
| | | | | | | | | | ambient- |
| | | | | | | | | | pressure |
| Example 9 | 1.0 | 240 | 100 | 0.6 | 2.0 | 0.6 | 1900 | 40 | burning at |
| | | | | | | | | | ambient- |
| | | | | | | | | | pressure |
| Example 10 | 1.5 | 240 | 100 | 0.9 | 2.0 | 0.6 | 1900 | 50 | burning at |
| | | | | | | | | | ambient- |
| | | | | | | | | | pressure |
| Comparative | 1.0 | 240 | 100 | 0.6 | 0.1 | 0.6 | 1900 | 50 | burning at |
| example 1 | | | | | | | | | ambient- |
| | | | | | | | | | pressure |
| Comparative | 1.0 | 240 | 100 | 0.6 | 20.0 | 0.6 | 1900 | 50 | burning at |
| example 2 | | | | | | | | | ambient- |
| | | | | | | | | | pressure |
| Comparative | 1.5 | 240 | 100 | 0.3 | 2.0 | 0.2 | 1900 | 50 | burning at |
| example 3 | | | | | | | | | ambient- |
| | | | | | | | | | pressure |
| Comparative | 1.0 | 240 | 100 | 1.0 | 2.0 | 1.0 | 1900 | 50 | burning at |
| example 4 | | | | | | | | | ambient- |
| | | | | | | | | | pressure |
| Comparative | 1.0 | 240 | 100 | 0.6 | 0.3 | 0.6 | 1900 | 50 | burning at |
| example 5 | | | | | | | | | ambient- |
| | | | | | | | | | pressure |
| Comparative | 1.0 | 240 | 100 | 0.6 | 6.0 | 0.6 | 1950 | 50 | burning at |
| example 6 | | | | | | | | | ambient- |
| | | | | | | | | | pressure |

TABLE 2

| | | | Aluminum nitride | | | | Volume resistivity after | |
|---|---|---|---|---|---|---|---|---|
| | | ESR Spin | Particle diameter | Thermal | Volume resistivity | | 6-hour heating at 1850° C. | |
| | Ratio of XRD | concentration | of sintered | conductivity | (Ω · cm) | | (Ω · cm) | |
| | peaks S2/S1 | (spins/cm³) | body (μm) | (W/m · K) | 25° C. | 500° C. | 25° C. | 500° C. |
| Example 1 | 0.10 | 3.4 × 10¹⁸ | 4.6 | 60 | 2.0 × 10¹¹ | 2.5 × 10⁸ | 3.1 × 10¹¹ | 4.5 × 10⁸ |
| Example 2 | 0.03 | 2.1 × 10¹⁶ | 6.2 | 72 | 9.3 × 10¹¹ | 5.6 × 10⁸ | 8.8 × 10¹¹ | 6.2 × 10⁸ |
| Example 3 | 0.08 | 8.2 × 10¹⁷ | 5.1 | 63 | 5.3 × 10¹¹ | 3.9 × 10⁸ | 6.1 × 10¹¹ | 4.3 × 10⁸ |
| Example 4 | 0.18 | 8.0 × 10¹⁸ | 4.2 | 60 | 8.8 × 10¹⁰ | 4.3 × 10⁸ | 8.0 × 10¹⁰ | 4.0 × 10⁸ |
| Example 5 | 0.11 | 3.2 × 10¹⁸ | 4.5 | 61 | 2.5 × 10¹¹ | 3.5 × 10⁸ | 3.0 × 10¹¹ | 4.0 × 10⁸ |
| Example 6 | 0.07 | 9.0 × 10¹⁷ | 5.5 | 65 | 7.3 × 10¹¹ | 4.4 × 10⁸ | 6.9 × 10¹¹ | 4.7 × 10⁸ |
| Example 7 | 0.20 | 9.5 × 10¹⁸ | 4.7 | 60 | 6.5 × 10¹⁰ | 2.1 × 10⁸ | 4.9 × 10¹¹ | 3.2 × 10⁸ |
| Example 8 | 0.15 | 6.9 × 10¹⁸ | 5.2 | 63 | 5.8 × 10¹⁰ | 3.2 × 10⁸ | 6.1 × 10¹⁰ | 3.8 × 10⁸ |
| Example 9 | 0.08 | 8.5 × 10¹⁷ | 5.0 | 61 | 5.0 × 10¹¹ | 3.1 × 10⁸ | 5.5 × 10¹¹ | 3.6 × 10⁸ |
| Example 10 | 0.10 | 3.0 × 10¹⁸ | 5.1 | 60 | 2.3 × 10¹¹ | 2.0 × 10⁸ | 2.7 × 10¹¹ | 2.6 × 10⁸ |
| Comparative | 0 | 6.5 × 10¹¹ | 6.5 | 73 | 8.1 × 10¹³ | 2.5 × 10⁷ | 2.1 × 10¹⁴ | 7.6 × 10⁸ |
| example 1 | | | | | | | | |
| Comparative | 0 | 8.1 × 10²⁴ | —¹⁾ | —¹⁾ | 2.6 × 10⁷ | —¹⁾ | —¹⁾ | —¹⁾ |
| example 2 | | | | | | | | |
| Comparative | 0 | 3.2 × 10¹¹ | —¹⁾ | —¹⁾ | 1.2 × 10¹⁴ | —¹⁾ | —¹⁾ | —¹⁾ |
| example 3 | | | | | | | | |
| Comparative | 0 | 1.5 × 10²³ | —¹⁾ | —¹⁾ | 3.9 × 10⁷ | —¹⁾ | —¹⁾ | —¹⁾ |
| example 4 | | | | | | | | |
| Comparative | 0.005 | 8.2 × 10¹¹ | 6.5 | 69 | 4.2 × 10¹³ | 6.2 × 10⁷ | 6.8 × 10¹³ | 7.8 × 10⁷ |
| example 5 | | | | | | | | |
| Comparative | 0.35 | 1.5 × 10²³ | 4.5 | 61 | 2.1 × 10⁹ | 1.5 × 10⁶ | 1.3 × 10⁹ | 8.7 × 10⁵ |
| example 6 | | | | | | | | |

¹⁾Since densification was not observed, measurement could not be carried out.

### INDUSTRIAL APPLICABILITY

The application of the aluminum nitride sintered body of the present invention is not specifically limited to; since the volume resistivity is 1×10⁸ Ω·m or more and 1×10¹² Ω·m or less, it can be suitably used for electrostatic chuck for etcher or CVD device as well as electrostatic chuck having heater.

1. An aluminum nitride sintered body in which the ratio of a peak area S2 of a diffraction peak at 2θ=34° or more and 35° or less corresponding to an aluminum oxynitride phase to a peak area S1 of a diffraction peak of an aluminum nitride crystal face [100] in X-ray diffraction, i.e. S2/S1, is 0.01 or more and 0.3 or less, and the spin concentration at a magnetic field between 336 mT and 342 mT as measured by an electron spin resonance method is 1×10¹⁵ spins/cm³ or more and 1×10²⁰ spins/cm or less.

2. The aluminum nitride sintered body according to claim 1, wherein total content of metal elements other than aluminum is 400 ppm or less.

3. The aluminum nitride sintered body according to claim 1, wherein sintering additive is not substantially contained.

4. The aluminum nitride sintered body according to claim 1, wherein volume resistivity at a temperature between 25° C. and 500° C. is 1×10⁸ Ω·cm or more and 1×10¹² Ω·cm or less.

5. A method for manufacturing the aluminum nitride sintered body comprising the step of sintering at ambient-pressure a mixed powder containing as sintering components: an aluminum nitride powder; and an α-alumina powder whose average particle diameter is 0.3 μm or more and 2 μm or less and ratio of the average particle diameter to that of aluminum nitride powder is within the range of 0.3 or more and 0.8 or less wherein 0.5 parts by mass or more and 5 parts by mass or less of α-alumina powder is added to 100 parts by mass of aluminum nitride powder.

6. (canceled)

7. The method for manufacturing the aluminum nitride sintered body according to claim 5, wherein the mixed powder is burnt at ambient-pressure under nitrogen atmosphere at a temperature between 1800° C. and 1950° C. for 30 to 100 hours.
